(19) United States
(12) Patent Application Publication
(10) Pub. No.: US 2018/0268704 A1
(43) Pub. Date: Sep. 20, 2018

(54) Logic Based Dispatch Control

(71) Applicant: Allstate Insurance Company, Northbrook, IL (US)

(72) Inventor: Chad Balk, Buffalo Grove, IL (US)

(21) Appl. No.: 15/460,653

(22) Filed: Mar. 16, 2017

(51) Int. Cl. G08G 1/00; G06Q 10/06

(52) U.S. Cl. CPC G08G 1/202; G06Q 10/06311

(57) ABSTRACT

Aspects of the disclosure relate to using systemic logic based on one or more escalation control thresholds to manage fulfillment of a dispatch. In some instances, a dispatch management server may receive data for each of one or more escalation control thresholds, monitor fulfillment of a dispatch after an incident based on each of the one or more escalation control thresholds, identify that at least one of the one or more escalation control thresholds has been surpassed, identify an available dispatch specialist out of a plurality of dispatch specialists to receive task management responsibilities, and assign the task management responsibilities to the dispatch specialist.

### FIELD

Aspects described herein are generally related to systems and devices for dispatch management. More specifically, aspects described herein relate to using systemic logic to manage fulfillment of a dispatch.

### BACKGROUND

In some instances, an incident and/or accident, whether related to real property or a vehicle, may necessitate the dispatch of emergency and/or assistance personnel. The timely fulfillment of such a dispatch may be paramount in ensuring the safety of those affected by the incident and/or accident, as well the integrity of the property or vehicle involved. In conventional dispatch systems, however, the dispatch is coordinated, but the fulfillment of the dispatch is not actively monitored leading to prolonged periods of unaccountability.

### BRIEF SUMMARY

Aspects of the disclosure address these and/or other technological shortcomings by using systemic logic to manage fulfillment of a dispatch. In particular, one or more aspects of the disclosure provide effective, efficient, scalable, and convenient technical solutions that address and overcome the technical problems associated with known dispatch systems. For example, one or more aspects of the disclosure provide techniques for using systemic logic based on one or more escalation control thresholds to manage fulfillment of a dispatch.

In accordance with one or more embodiments, a dispatch management server having at least one processor, a memory, and a communication interface may receive data for each of one or more escalation control thresholds. Subsequently, the dispatch management server may monitor fulfillment of a dispatch after an incident based on each of the one or more escalation control thresholds. The dispatch management server may identify that at least one of the one or more escalation control thresholds has been surpassed. Responsive to identifying that at least one of the one or more escalation control thresholds has been surpassed, the dispatch management server may identify a dispatch specialist out of a plurality of dispatch specialists to receive task management responsibilities. Responsive to identifying the available dispatch specialist out of the plurality of dispatch specialists to receive the task management responsibilities, the dispatch management server may assign the task management responsibilities to the dispatch specialist.

In some embodiments, the one or more escalation control thresholds may include at least an estimated time of arrival (ETA) of the dispatch, ETA extensions taken by the dispatch, and dispatch number associated with the incident.

In some embodiments, the one or more escalation control thresholds may include at least a predictive ETA. To monitor fulfillment of the dispatch after the incident based on each of the one or more escalation control thresholds, the dispatch management server may access, via the communication interface, a telematics device associated with the dispatch. The dispatch management server may identify, based on the accessed telematics device associated with the dispatch, a relative location of the dispatch in relation to a requester of the dispatch. The dispatch management server may calculate the predictive ETA based on the relative location.

In some embodiments, to identify the available dispatch specialist out of the plurality of dispatch specialists to receive the task management responsibilities, the dispatch management server may access a database comprising information corresponding to each of the plurality of dispatch specialists. From the database, the dispatch management server may generate a list of available dispatch specialists out of the plurality of dispatch specialists by excluding dispatch specialists that are unavailable, work in a group not associated with the dispatch, and/or have a time conflict. The dispatch management server may sort the list of available dispatch specialists based on predetermined criteria. The dispatch management server may identify, from the sorted list of available dispatch specialists, the available dispatch specialist occupying a top most entry of the sorted list to receive the task management responsibilities.

In some embodiments, the dispatch management server may receive, from the dispatch specialist assigned the task management responsibilities, an update regarding the fulfillment of the dispatch. The dispatch management server may transmit, by the communication interface, the update to a requester of the dispatch.

In some embodiments, the dispatch management server may refresh, based on the update regarding the fulfillment of the dispatch, each of the one or more escalation control thresholds. The dispatch management server may monitor fulfillment of the dispatch based on each of the one or more refreshed escalation control thresholds. The dispatch management server may identify that at least one of the one or more refreshed escalation control thresholds has been surpassed. Responsive to identifying that at least one of the one or more refreshed escalation control thresholds has been surpassed, the dispatch management server may transmit a cancelation notification to the dispatch. The dispatch management server may then request a new dispatch.

These features, along with many others, are discussed in greater detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computing environment for using systemic logic to manage fulfillment of a dispatch in accordance with one or more aspects of the disclosure;

FIGS. 2A, 2B, 2C, 2D, 2E, and 2F depict an illustrative event sequence for using systemic logic to manage fulfillment of a dispatch in accordance with one or more aspects of the disclosure;

FIG. 3 depicts an illustrative method for using systemic logic to manage fulfillment of a dispatch in accordance with one or more aspects of the disclosure; and

FIG. 4 illustrates a network environment and computing systems that may be used to implement one or more aspects of the disclosure.

### DETAILED DESCRIPTION

In the following description of the various embodiments, reference is made to the accompanying drawings, which form a part hereof, and in which is shown by way of illustration various embodiments in which aspects described herein may be practiced. It is to be understood that other embodiments may be utilized and structural and functional modifications may be made without departing from the scope of the described aspects and embodiments. Aspects described herein are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

As will be appreciated by one of skill in the art upon reading the following disclosure, various aspects described herein may be embodied as a method, a computer system, or a computer program product. Accordingly, those aspects may take the form of an entirely hardware embodiment, an entirely software embodiment or an embodiment combining software and hardware aspects. In addition, aspects may take the form of a computing device configured to perform specified actions. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

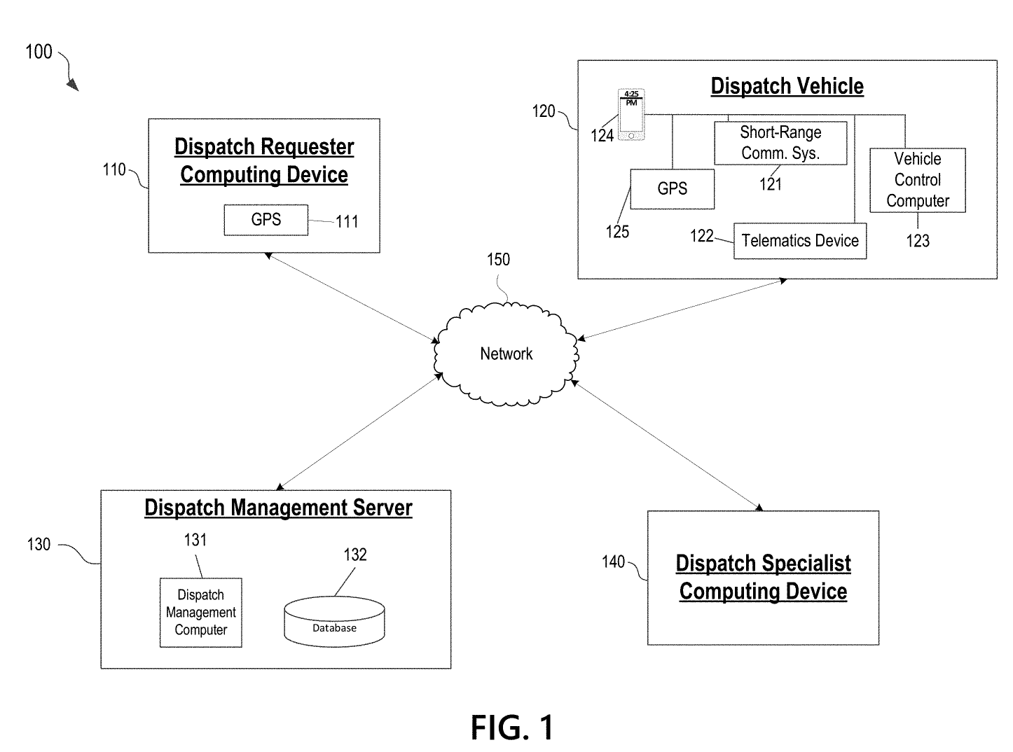

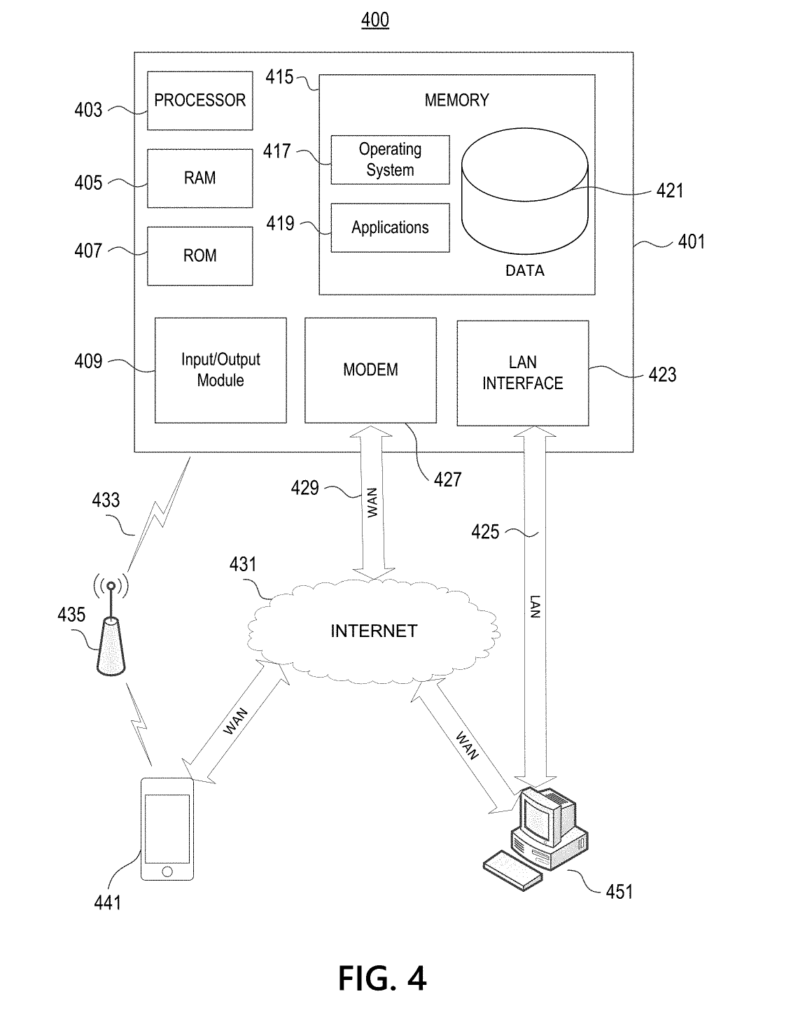

FIG. 1 depicts an illustrative dispatch management system 100 including a dispatch requester computing device 110, a dispatch vehicle 120, a dispatch management server 130, and a dispatch specialist computing device 140. Each of the dispatch requester computing device 110, dispatch vehicle 120, dispatch management server 130, and dispatch specialist computing device 140 may be configured to communicate with each other, as well as other computing devices, through network 150. Additionally, each component shown in FIG. 1 may be implemented in hardware, software, or a combination of the two. Furthermore, each component of the dispatch management system 100 may include a computing device (or system) having some or all of the structural components of dispatch control computing device 401 described below in regard to FIG. 4.

Dispatch requester computing device 110 may be associated with a dispatch requester, who may be an individual affected by an incident and/or accident related to real property (e.g., home, apartment, condominium, business, or other property) and/or a vehicle (e.g., automobile, motorcycle, scooter, bus, recreational vehicle, boat, or other vehicle). In instances in which the incident and/or accident is related to a vehicle, the incident and/or accident may further correspond to a one-vehicle accident, multi-vehicle accident, vehicle breakdown, inability to access a vehicle (e.g., locked out of vehicle), and the like. In instances in which the incident and/or accident is related to a home, the incident and/or accident may further correspond to a break-in, fire, plumbing issue, inability to access home (e.g., locked out of residence), and the like.

The dispatch requester computing device 110 may be configured to receive and transmit information corresponding to a dispatch request, receive information corresponding to updates regarding the dispatch request, transmit location information, and the like. The dispatch requester computing device 110 may include GPS 111, which may be utilized in determining a location associated with the vehicle or home of the dispatch requester involved in the incident and/or accident. Such transmittal and reception processes as described above may be performed through an application, web application, calling interface, text interface, and/or other communication interface configured to facilitate interaction with one or more of dispatch vehicle 120 and the computing devices included therein (e.g., telematics device 123, vehicle control computer 124, mobile device 125, and the like), dispatch management server 130, and dispatch specialist computing device 140.

Dispatch vehicle 120 in the dispatch management system 100 may be of a particular type corresponding to the nature of the dispatch request. For instance, in the event that the dispatch request is related to a broken down vehicle, the dispatch vehicle 120 may be a tow truck. Similarly, in the event that the dispatch request is related to a plumbing incident, the dispatch vehicle 120 may be a related to a plumber. As such, dispatch vehicle 120 may be, for example, an automobile, motorcycle, scooter, bus, truck, tow truck, recreational vehicle, commercial vehicle, emergency response vehicle, boat, or other vehicle corresponding to the nature of the dispatch request. In some instances, while not explicitly shown, dispatch vehicle 120 may be one of a plurality of vehicles.

The dispatch vehicle 120 may include short-range communication systems 121, telematics device 122, vehicle control computer 123, mobile computing device 124, and/or GPS 125. Such components either operating alone or in tandem may be configured to receive and transmit information corresponding to a dispatch request, receive information corresponding to updates regarding the dispatch request, transmit location information, and the like.

Short-range communication system 121 may be a vehicle-based data transmission system, which may be configured to transmit data to, and receive data from, one or more of dispatch requester computing device 110, dispatch management server 130, and dispatch specialist computing device 140. In some examples, communication system 121 may use dedicated short-range communications (DSRC) protocols and standards to perform wireless communications. However, short-range communication system 121 need not use DSRC, and may be implemented using other short-range wireless protocols in other examples, such as WLAN communication protocols (e.g., IEEE 802.11), Bluetooth (e.g., IEEE 802.15.1), or one or more of the Communication Access for Land Mobiles (CALM) wireless communication protocols and air interfaces. In certain examples, short-range communication system 121 may include specialized hardware installed in dispatch vehicle 120 (e.g., transceivers, antennas, and the like), while in other examples the communication system 121 may be implemented using existing vehicle hardware components (e.g., radio and satellite equipment, navigation computers, and the like) or may be implemented by software running on the mobile device 124 of a drivers or passengers within the vehicle 120.

Telematics device 122 may be a computing device containing many or all of the hardware/software components as the dispatch control computing device 401 depicted in FIG. 4. Telematics device 122 may be configured to communicate with one or more of short range communication system 121, vehicle control computer 123, mobile computing device 124, and GPS 125. Additionally, the telematics device 122 may be configured to receive, store, and transmit vehicle data (e.g., location data from GPS 125) to one or more of dispatch requester computing device 110, dispatch management server 130, and dispatch specialist computing device 140. Telematics device 122 also may be configured to independently detect or determine vehicle data such as location information. As will be described in further detail below, in some instances, telematics device 122 of dispatch vehicle 120 may be configured to be accessed and/or controlled by dispatch management server 130 and/or dispatch specialist computing device 140 to provide information corresponding to a location of dispatch vehicle 120.

Vehicle control computer 123 may be a computing device containing many or all of the hardware/software components as the dispatch control computing device 401 depicted in FIG. 4. Vehicle control computer 123 may be configured to communicate with one or more of short range communication system 121, telematics device 122, mobile computing device 124, and GPS 125. In some instances, vehicle control computing device 123 may be configured to receive and transmit information corresponding to a dispatch request, receive information corresponding to updates regarding the dispatch request, transmit location information, and the like. Such transmittal and reception processes may be performed through an application, web application, calling interface, text interface, and/or other communication interface configured to facilitate interaction with one or more of dispatch requester computing device 110, dispatch management server 130, and dispatch specialist computing device 140. Additionally, vehicle control computer 123 may be configured to interface with a display screen through which information concerning the dispatch may be displayed.

Mobile computing device 124 may be a computing device containing many or all of the hardware/software components as the dispatch control computing device 401 depicted in FIG. 4. Mobile computing device 124 may be configured to communicate with one or more of short range communication system 121, telematics device 122, vehicle control computer 123, and GPS 125. In some instances, mobile computing device 124 may be configured to receive and transmit information corresponding to a dispatch request, receive information corresponding to updates regarding the dispatch request, transmit location information, and the like. Such transmittal and reception processes may be performed through an application, web application, calling interface, text interface, and/or other communication interface configured to facilitate interaction with one or more of dispatch requester computing device 110, dispatch management server 130, and dispatch specialist computing device 140. Additionally, mobile computing device 124 may also be configured to independently detect or determine vehicle data such as location information.

GPS 125 may be configured to determine, store, and transmit locational information corresponding to dispatch vehicle 120. In some instances, GPS 125 may be configured to transmit location information to one or more of short range communication system 121, telematics device 122, vehicle control computer 123, and mobile computing device 124.

The dispatch management system 100 also may include dispatch management server 130, containing some or all of the hardware/software components as the dispatch control computing device 401 depicted in FIG. 4. The dispatch management server 130 may be configured to communicate with dispatch requester computing device 110, components of dispatch vehicle 120 including short-range communication system 121, telematics device 122, vehicle control computer 123, and mobile device 124, and dispatch specialist computing device 140. Dispatch management server 130 may include dispatch management computer 131 and dispatch management database 132.

The dispatch management computer 131 of dispatch management server 130 may be configured to receive data for each of one or more escalation control thresholds, monitor fulfillment of a dispatch after an incident based on each of the one or more escalation control thresholds, identify that at least one of the one or more escalation control thresholds has been surpassed, identify an available dispatch specialist out of a plurality of dispatch specialists to receive task management responsibilities, and assign the task management responsibilities to the dispatch specialist. As will be described in further detail below, dispatch management server 130 may perform additional functions by way of dispatch management computing device 131.

The dispatch management database 132 may store information related to the performance of the dispatch management processes. In particular, dispatch management database 132 may store a plurality of dispatch profiles, which may be created upon the receipt of a dispatch request at dispatch management server 130. The dispatch profiles may include information such as a name of a dispatch requester, insurance information of the dispatch requester, timestamp of transmittal of a dispatch request, type of incident and/or accident corresponding to the dispatch request (e.g., vehicle accident, plumbing incident, locked out of property/vehicle, and the like), and locational data corresponding to the location of the incident and/or accident. Furthermore, the dispatch profiles may be configured to include information corresponding to the dispatch vehicle enlisted with fulfilling the dispatch request. Such information may include an identification number of the dispatch vehicle, as well data corresponding to the fulfillment of the dispatch in relation to the escalation control thresholds.

Additionally, dispatch management database 132 may store information related to each of a plurality of dispatch vehicles. Such information may include a type associated with the dispatch vehicle (e.g., tow truck, plumber, electrician, locksmith, and the like), a real-time indication of availability of the dispatch vehicle (e.g., available, unavailable), a dispatch schedule associated with the dispatch vehicle, and a real-time location associated with the dispatch vehicle.

Furthermore, the dispatch management database 132 may store information related to each of a plurality of dispatch specialists who may be individuals responsible for monitoring fulfillment of a dispatch after an escalation control threshold has been surpassed. Such information may include a name and contact information of the dispatch specialist, a real-time indication of availability of the dispatch specialist (e.g., available, unavailable), a schedule associated with the dispatch specialist, and a group associated with the dispatch specialist. Such groups may be related to an area of specialty such as property or vehicle, may relate to a specific type of property or vehicle (e.g., house, truck, boat, and the like), and/or may relate to a specific manufacturer of vehicle.

The dispatch management system 100 also may include dispatch specialist computing device 140, containing some or all of the hardware/software components as the dispatch control computing device 401 depicted in FIG. 4. The dispatch specialist computing device 140 may be associated with a dispatch specialist and may be configured to communicate with dispatch requester computing device 110, components of dispatch vehicle 120 including short-range communication system 121, telematics device 122, vehicle control computer 123 and mobile device 124, and dispatch management server 130. In some instances, while not explicitly shown, dispatch specialist computing device 140 may be one of a plurality of computing devices, each of which being associated with a particular dispatch specialist.

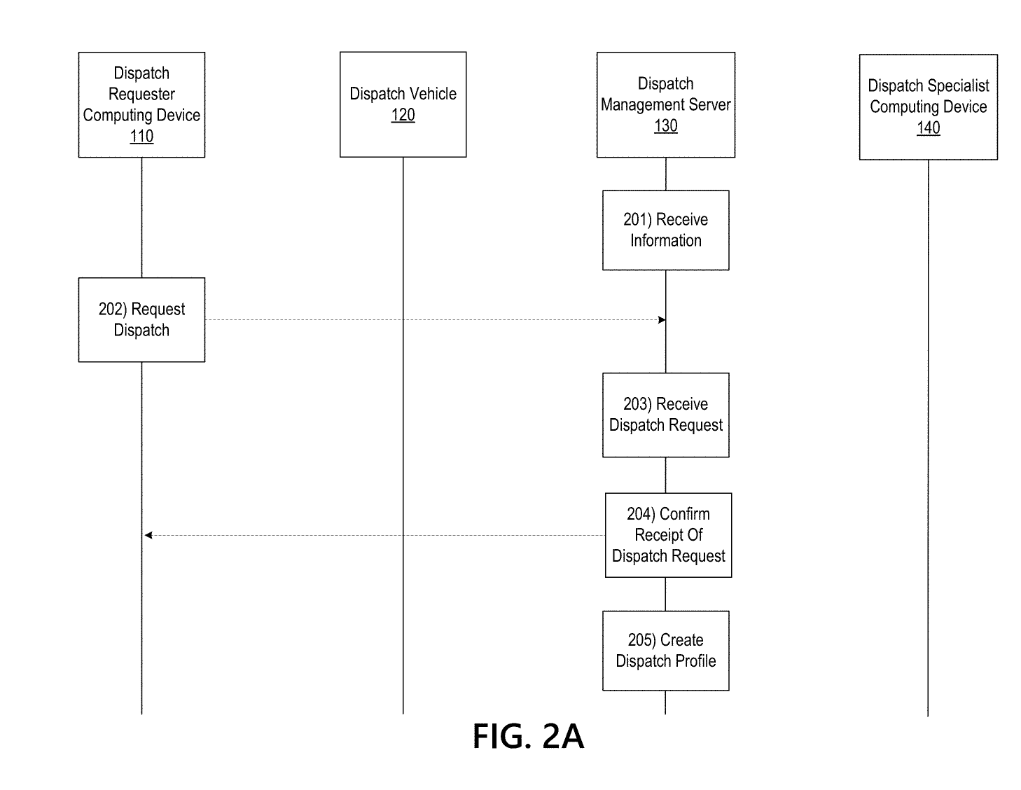

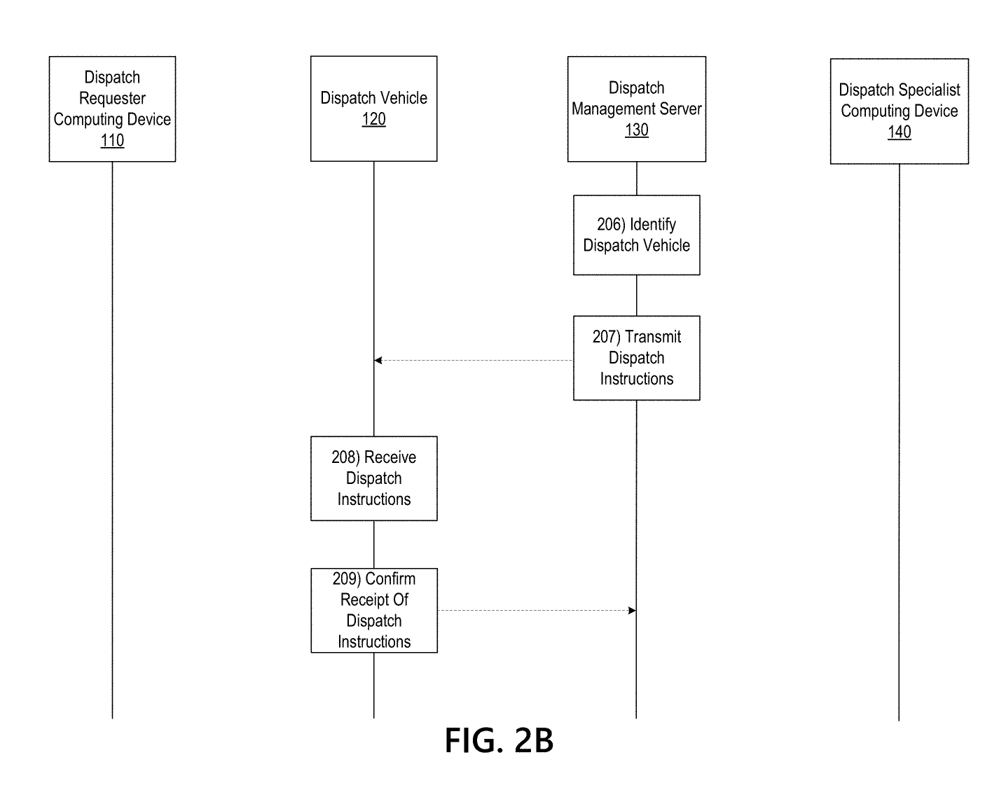

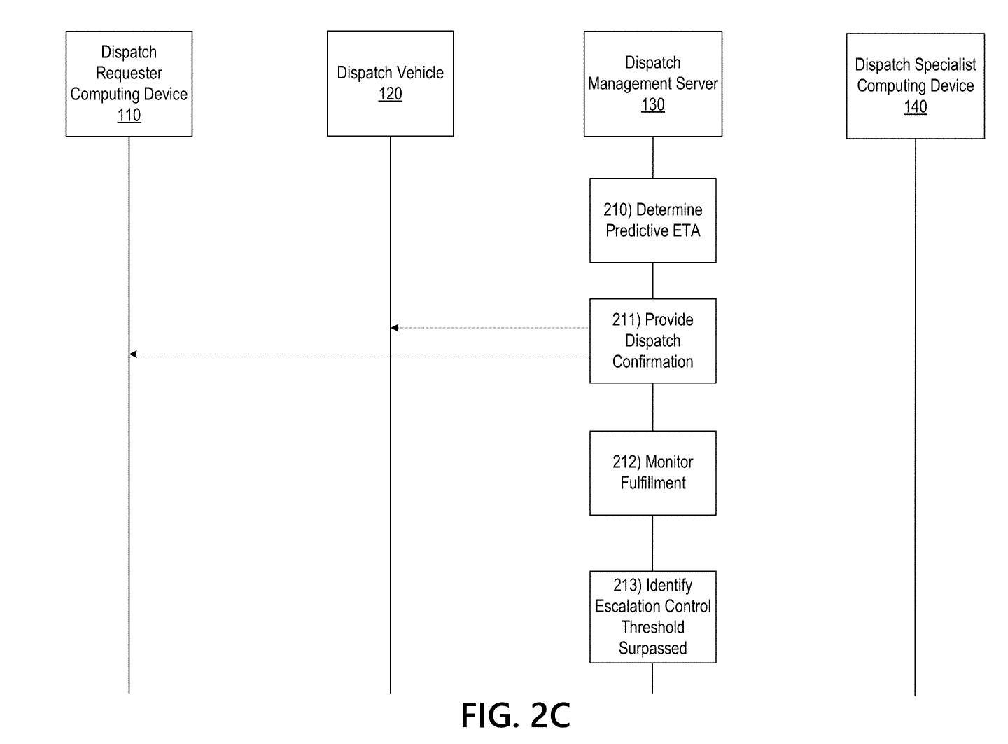

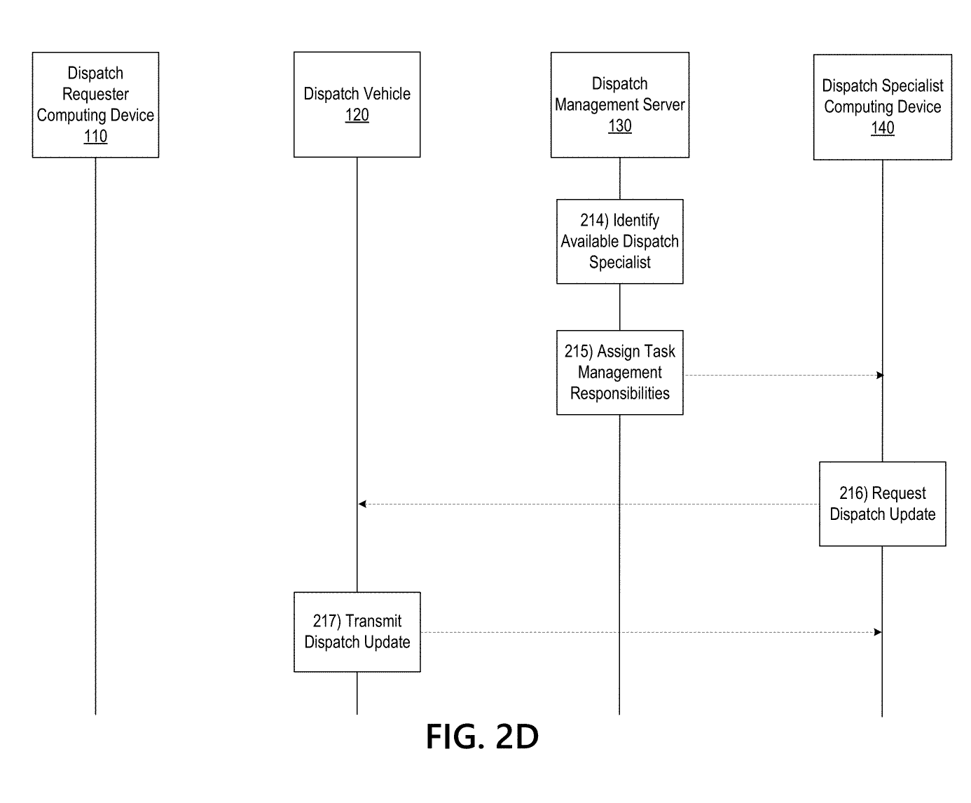

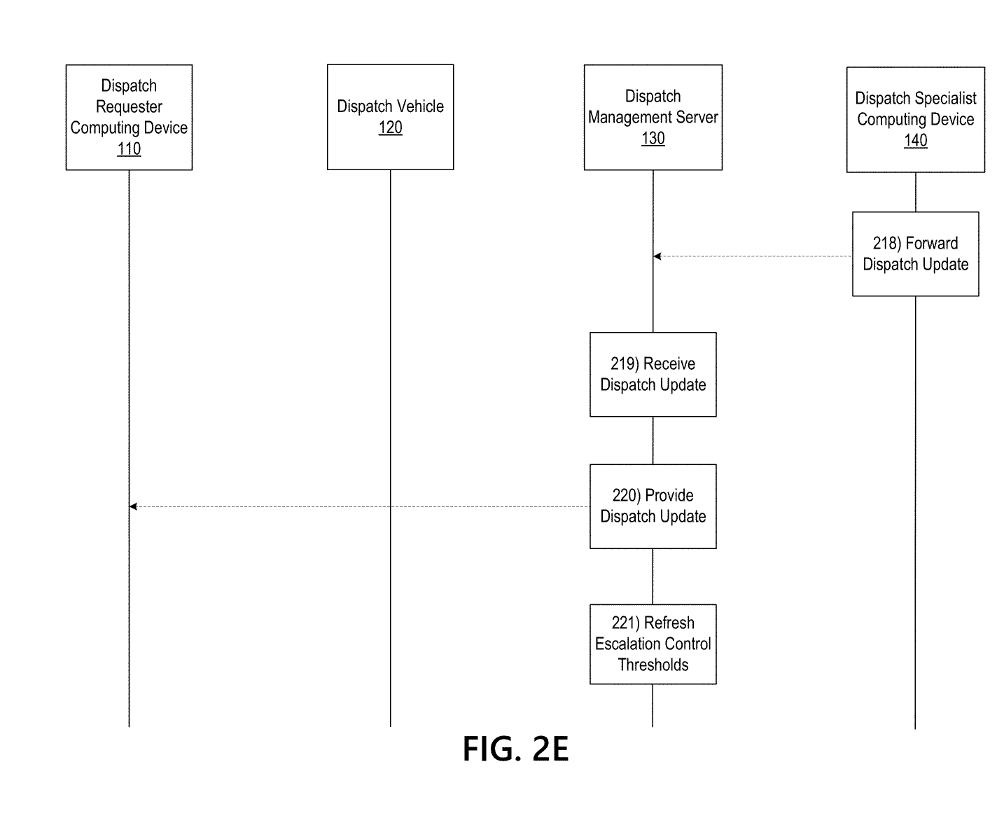

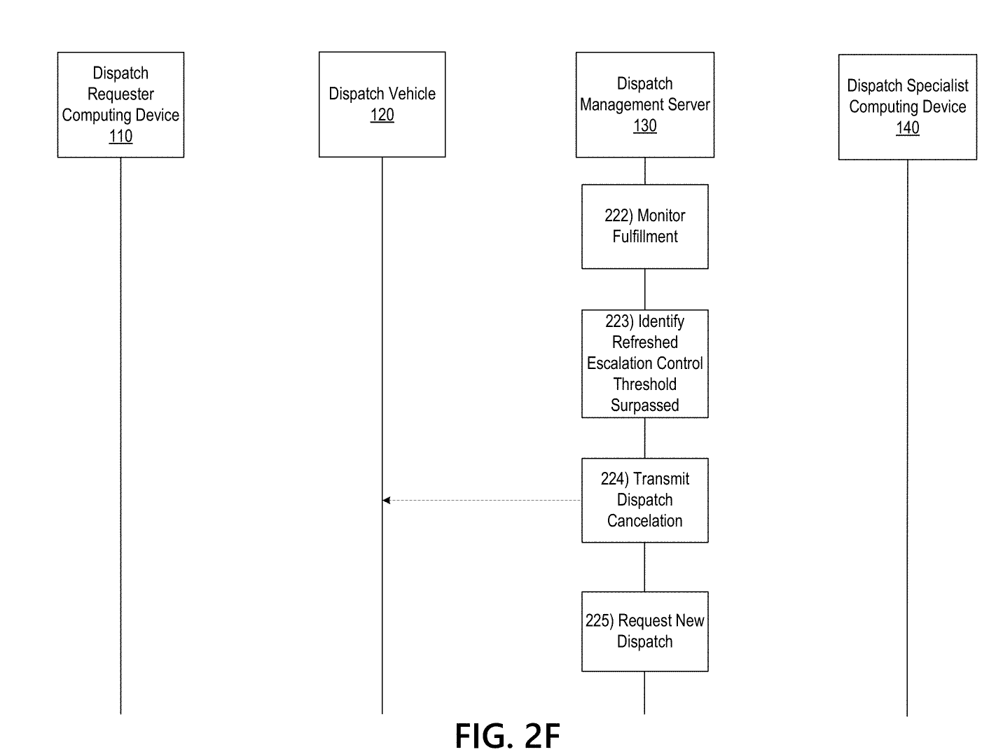

FIGS. 2A, 2B, 2C, 2D, 2E, and 2F depict an illustrative event sequence for using systemic logic to manage fulfillment of a dispatch in accordance with one or more aspects of the disclosure. The event sequence described below in regard to FIGS. 2A, 2B, 2C, 2D, 2E, and 2F may include processing steps performed in response to an incident and/or accident involving real property or a vehicle of a user or dispatch requester. While the steps shown in FIGS. 2A, 2B, 2C, 2D, 2E, and 2F are presented sequentially, the steps need not follow the sequence presented and may occur in any order.

Referring to FIG. 2A, at step 201, dispatch management server 130 may receive information for each of the one or more escalation control thresholds related to an estimated time of arrival (ETA) of a dispatch, ETA extensions taken by a dispatch, and dispatch number associated with an incident. The escalation control thresholds may establish systemic logic through which the dispatch management server 130 may monitor fulfillment of a dispatch. Such information corresponding to the escalation control thresholds may be stored by dispatch management computing device 131 of dispatch management server 130 in dispatch management database 132.

At step 202, a user associated with dispatch requester computer device 110 may transmit a dispatch request to dispatch management server 130. The dispatch request may include information such as a name and contact information of the requester, insurance information of the requester, timestamp of transmittal of the request, type of incident and/or accident corresponding to the request (e.g., vehicle accident, plumbing incident, locked out of property/vehicle, and the like), and/or locational data corresponding to the location of the incident and/or accident.

At step 203, the dispatch management server 130 may receive the dispatch request from dispatch requester computing device 110. At step 204, the dispatch management computing device 131 of the dispatch management server 130 may provide a notification to dispatch requester computing device 110 confirming the receipt of the dispatch request. Additionally, the notification may indicate that a dispatch is being arranged regarding the request and that a confirmation will be provided upon arrangement.

At step 205, the dispatch management computing device 131 of dispatch management server 130 may create a dispatch profile in dispatch management database 132. The dispatch profile may be associated with the dispatch request received from dispatch requester computing device 110 and, as such, may include the information corresponding to the dispatch request including name and contact information of the requester, insurance information of the requester, the timestamp, type of incident and/or accident, and locational data corresponding to the location of the incident and/or accident.

Referring to FIG. 2B, at step 206, the dispatch management computing device 131 of dispatch management server 130 may identify a dispatch vehicle 120 to fulfill the dispatch request provided at step 201. To do so, dispatch management computing device 131 may sort dispatch vehicle information, which may be stored in dispatch management database 132, based, in some examples, on the information included in the dispatch profile. The dispatch management computing device 131 may isolate dispatch vehicles corresponding to the type of incident and/or request. For example, if the type of incident and/or accident is indicated as being a vehicle malfunction, dispatch management computing device 132 may isolate dispatch vehicles categorized as tow trucks in dispatch management database 132. The dispatch management computing device 131 may exclude the dispatch vehicles categorized as tow trucks that are unavailable. For the remaining dispatch vehicles, the dispatch management computing device 131 may identify and/or select the dispatch vehicle 120 closest to the location of the incident and/or accident based on locational data associated with the dispatch vehicles provided by one or more of the GPS, telematics device, and/or mobile device associated with the vehicle. In some instances, the dispatch management computing device 131 may be configured to override an existing dispatch assignment to address the dispatch request provided at step 202 if the request is associated with a priority requester and/or if the request has been pending for a greater period of time than the request from which the dispatch vehicle is being reassigned. Additionally, after identifying and/or selecting the dispatch vehicle 120 to fulfill the dispatch request received at step 202, the dispatch management computing device 131 may update the dispatch profile associated with the dispatch request to include the information of the dispatch vehicle 120, as well as the dispatch operator/technician corresponding to the dispatch vehicle 120.

At step 207, the dispatch management computing device 131 of dispatch management server 130 may transmit dispatch instructions to one or more of the vehicle control computer 123 and mobile device 124 associated with the identified dispatch vehicle 120. The dispatch instructions may include information corresponding to the dispatch request and dispatch requester including the name and contact information of the requester, time of the request, the type of the request, and locational data corresponding to the location of the incident and/or accident.

At step 208, one or more of the vehicle control computer 123 and mobile device 124 of the dispatch vehicle 120 may receive the dispatch instructions from the dispatch management device 131 of dispatch management server 130. At step 208, an operator and/or technician associated with dispatch vehicle 120 may confirm receipt of the dispatch instructions via an interaction through one or more of the vehicle control computer 123 and mobile device 124 (e.g., via an interactive user interface displayed on a display of the vehicle control computer 123 and/or mobile device 124) which may cause the vehicle control computer 123 and/or mobile device 124 to provide a confirmation of receipt of the dispatch instructions to dispatch management server 130.

Referring to FIG. 2C, at step 210, in instances in which a predicative ETA for the arrival of the dispatch is used, the dispatch management computing device 131 may determine the predictive ETA. To do so, the dispatch management computing device 131 may access the telematics device 122 associated with the dispatch vehicle 120 to determine a location of the dispatch vehicle 120. In some instances, the dispatch management computing device may request location information from the vehicle control computer 123 and/or mobile device 124 of dispatch vehicle 120. Subsequently, the dispatch management computing device 131 may compare the location information of the dispatch vehicle 120 to the location information associated with the incident and/or accident noted in the dispatch request to determine a predictive ETA for the dispatch vehicle to arrive at the location of the incident and/or accident. During the comparison, the dispatch management computing device 131 may utilize traffic levels in determining the predictive ETA. In instances in which a predictive ETA is not used, however, step 210 may be omitted.

At step 211, the dispatch management computing device 131 of the dispatch management server 130 may provide a dispatch confirmation to the dispatch requester computing device 110 and one or more of the vehicle control computer 123 and mobile device 124 of the dispatch vehicle 120. The dispatch confirmation may include information corresponding to the dispatch requester and dispatch operator/technician including name and contact information, the location to where the dispatch vehicle 120 is being dispatched, the time of the dispatch request, and an estimated ETA or a predictive ETA of the dispatch. In instances in which an estimated ETA is used, the estimated ETA may be provided by the dispatch operator/technician or may be a predetermined value (e.g., 1 hour, 2 hours, or the like). Alternatively, the estimated ETA may be a predetermined number provided by a system administrator of dispatch management server 130 and stored in dispatch management database 132. In instances in which the predictive ETA is used, the predictive ETA may be provided based on the time determined in step 210.

At step 212, the dispatch management computing device 131 may monitor fulfillment of the dispatch after the incident and/or accident based on each of the one or more escalation control thresholds. To do so, in some instances, dispatch management computing device 131 of dispatch management server 130 may activate a timer responsive to providing the dispatch confirmation in step 211. The dispatch timer may run continuously from a point of commencement (e.g., providing the dispatch confirmation) until the dispatch is fulfilled, which may be indicated by a dispatch arrival confirmation provided by one or more of a dispatch technician/operator of the dispatch vehicle 120 via one or more of the vehicle control computer 123 and the mobile device 124 and the dispatch requester via the dispatch requester computing device 110.

Additionally and/or alternatively, the dispatch fulfillment may be indicated by a location of the dispatch vehicle 120 coinciding with that of the locational data corresponding to the location of the incident and/or accident. In such instances, the location of the dispatch vehicle 120 compared to the locational data corresponding to the location of the incident and/or accident may be required to be within a predetermined range (e.g., 10 feet, 20 feet, etc.) of each other. The location of the dispatch vehicle 120 may be determined by dispatch management computing device 131 either continuously or periodically (e.g., every 30 seconds, 1 minute, etc.) by accessing one or more of telematics device 122, vehicle control computer 123, mobile device 124, and GPS 125 of dispatch vehicle 120.

The dispatch timer may be observed in relation to each of the one or more escalation control thresholds. For example, in regard to the escalation control threshold related to the ETA of the dispatch, the dispatch management computing device 131 may monitor the fulfillment of the dispatch in relation to the ETA. If the dispatch is fulfilled before the ETA expires (e.g., a dispatch arrival confirmation is provided before the ETA expires), then the escalation control threshold associated with the ETA of the dispatch may not be surpassed. Conversely, if the dispatch is not fulfilled before the ETA expires (e.g., a dispatch arrival confirmation is not provided before the ETA expires), then the escalation control threshold associated with the ETA of the dispatch may be surpassed.

In regard to the escalation control threshold related to the number ETA extensions taken by the dispatch vehicle 120, the dispatch management computing device 131 may monitor the fulfillment of the dispatch in relation to the number of ETA extensions taken based on the dispatch timer. In some instances, an ETA extension may be indicated by a dispatch operator/technician of dispatch vehicle 120 by way of one or more of the vehicle control computer 123 and the mobile device 124. The ETA extension may be a period of time indicated by the dispatch operator/technician beyond the ETA. For example, if an ETA associated with a dispatch is set to expire and a dispatch vehicle 120 is stuck in traffic, a dispatch operator/technician of the dispatch vehicle 120 may provide an ETA extension of 30 minutes to dispatch management server 130 by way of one or more of the vehicle control computer 123 and the mobile device 124. In other instances, the ETA extension may be a predetermined period of time (e.g., 20 minutes, 1 hour, etc.) allotted by dispatch management server 130 in response to an ETA extension request provided by a dispatch operator/technician of the dispatch vehicle by way of one or more of the vehicle control computer 123 and the mobile device 124.

In either case, if a predetermined number of ETA extensions are taken before the dispatch is fulfilled (e.g., one ETA extension, two ETA extensions, etc. are taken before a dispatch arrival confirmation is provided), then the escalation control threshold related to the number ETA extensions may be surpassed. Conversely, if the predetermined number of ETA extensions is not taken before the dispatch is fulfilled (e.g., one ETA extension, two ETA extensions, etc. are not taken before a dispatch arrival confirmation is provided), then the escalation control threshold related to the number ETA extensions may not be surpassed.

In regard to the escalation control threshold related to the dispatch number associated with the dispatch request, the dispatch management computing device 131 may monitor the fulfillment of the dispatch in relation to the dispatch number associated with the dispatch request based on the dispatch timer. In some instances, a new dispatch may be required if a dispatch is canceled by a dispatch operator/technician of dispatch vehicle 120 or by dispatch management server 130. If a predetermined number of dispatches are sent out before the dispatch is fulfilled (e.g., one dispatch, two dispatches, etc. are sent out before a dispatch arrival confirmation is provided), then the escalation control threshold may be surpassed. Conversely, if the predetermined number of dispatches are not sent out before the dispatch is fulfilled (e.g., one dispatch, two dispatches, etc. are not sent out before a dispatch arrival confirmation is provided), then the escalation control threshold may not be surpassed.

In regard to the escalation control threshold associated with the predictive ETA, the dispatch management computing system 131 may monitor the fulfillment of the dispatch in relation to predictive ETA determined at step 210 based on the dispatch timer. If the dispatch is fulfilled before the predictive ETA expires (e.g., a dispatch arrival confirmation is provided before the predictive ETA expires), then the escalation control threshold associated with the predictive ETA of the dispatch may not be surpassed. Conversely, if the dispatch is not fulfilled before the predictive ETA expires (e.g., a dispatch arrival confirmation is not provided before the ETA expires), then the escalation control threshold associated with the predictive ETA of the dispatch may be surpassed.

At step 213, the dispatch management computing device 131 may identify that at least one or more of the escalation control thresholds has been surpassed. As stated above the escalation control thresholds may relate to the ETA of the dispatch, ETA extensions taken by a dispatch, dispatch number associated with an incident, and predictive ETA of the dispatch. To identify that the escalation control threshold associated with the ETA of the dispatch has been surpassed, the dispatch management computing device 131 may fail to receive an indication that the dispatch has been fulfilled (e.g., dispatch arrival confirmation) by the time that the ETA has expired. To identify that the escalation control threshold associated with the number of extensions taken by the dispatch has been surpassed, the dispatch management computing device 131 may receive a number of ETA extensions from one or more of the vehicle control computer 123 and the mobile device 124 of the dispatch vehicle 120 in excess of the escalation control threshold. To identify that the escalation control threshold associated with the dispatch number has been surpassed, the dispatch management computing device 131 may have dispatched more than the number of dispatches associated with the threshold. To identify that the escalation control threshold associated with the predictive ETA of the dispatch has been surpassed, the dispatch management computing device 131 may fail to receive an indication that the dispatch has been fulfilled by the time that the predictive ETA has expired.

Referring to FIG. 2D, at step 214, responsive to identifying that at least one of the one or more escalation control thresholds has been surpassed, the dispatch control computing device 131 may identify an available dispatch specialist out of a plurality of dispatch specialists to receive task management responsibilities corresponding to the dispatch request. To do so, the dispatch control computing device 131 may dispatch control database 132 comprising information corresponding to each of the dispatch control specialists. The dispatch control computing device 131 of the dispatch control server 130 may generate a list of available dispatch specialists by excluding dispatch specialists that are unavailable, work in a group that is not associated with the dispatch request, and/or have an upcoming time conflict based on their schedule. Responsive to generating the list of available dispatch specialists, the dispatch control computing device 131 may sort the list of available dispatch specialists based on predetermined criteria, which may include an order of alphabetization, proximity to location of the incident, and/or a customer service rating associated with the specialists. After sorting the list of available dispatch specialists, the dispatch control computing device 131 may identify an available dispatch specialist occupying a top most entry of the sorted listed either alphabetically, by proximity, and/or based on a highest customer service rating to receive the task management responsibilities. The task management responsibilities may include instructions to follow up with the dispatch operator/technician by way of one or more of the vehicle control computer 123 and the mobile device 124 of the dispatch vehicle 120 and/or the dispatch requester by way of the dispatch requester computing device 110.

At step 215, the dispatch control computing device 131 may assign the task management responsibilities to the identified available dispatch specialist by transmitting a notification comprising the task management responsibilities to the dispatch specialist computing device 140 associated with the available dispatch specialist. The dispatch specialist may be responsible for monitoring the dispatch request until fulfillment.

At step 216, per the task management responsibilities, the dispatch specialist, by way of the dispatch specialist computing device 140, may request a dispatch update from one or more of the vehicle control computer 123 and the mobile device 124 of the dispatch vehicle 120. At step 217, the dispatch operator/technician of the dispatch vehicle 120 may provide the requested dispatch update to the dispatch specialist computing device 140 by way one or more of the vehicle control computer 123 and the mobile device 124 of the dispatch vehicle 120. In some instances, the dispatch update may include a revised ETA for the dispatch, an ETA extension, and/or location information associated with the dispatch vehicle 120.

Referring to FIG. 2E, at step 218, the dispatch specialist computing device 140 may forward the dispatch update to dispatch management server 130. At step 219, the dispatch management computing device 131 of dispatch management server 130 may receive the dispatch update from the dispatch specialist computing device 140 and, at step 220, the dispatch management computing device 131 may provide the dispatch update to the dispatch requester computing device 110.

At step 221, dispatch management computing device 131 of the dispatch management server 130 may refresh one or more of the escalation control thresholds based on the dispatch update provided by the dispatch specialist computing device 140. For example, in regard to the escalation control threshold related to the ETA of the dispatch, the dispatch management computing device 131 may update the escalation control threshold based on an updated ETA provided by the dispatch operator/technician of the dispatch vehicle 120. In regard to the escalation control threshold related to the number ETA extensions taken by the dispatch vehicle 120, the dispatch management computing device 131 may update the escalation control threshold to reflect that an ETA extension has been taken. In regard to the escalation control threshold associated with the predictive ETA, the dispatch management computing system 131 may update the predictive ETA based on the location information provided in the dispatch update at step 217.

Referring to FIG. 2F, at step 222, the dispatch management computing device 131 of the dispatch management server 130 may monitor fulfillment of the dispatch based on the one or more refreshed escalation control thresholds in a manner similar to that described above in regard to step 212.

At step 223, the dispatch management computing device 131 may identify that at least one or more of the refreshed escalation control thresholds has been surpassed in a manner similar to that described above in regard to step 213. For example, to identify that the refreshed escalation control threshold associated with the ETA of the dispatch has been surpassed, the dispatch management computing device 131 may fail to receive an indication that the dispatch has been fulfilled (e.g., dispatch arrival confirmation) a by the time that the ETA has expired. To identify that the refreshed escalation control threshold associated with the number of extensions taken by the dispatch has been surpassed, the dispatch management computing device 131 may receive a number of ETA extensions from one or more of the vehicle control computer 123 and the mobile device 124 of the dispatch vehicle 120 in excess of the refreshed escalation control threshold. To identify that the refreshed escalation control threshold associated with the predictive ETA of the dispatch has been surpassed, the dispatch management computing device 131 may fail to receive an indication that the dispatch has been fulfilled by the time that the predictive ETA has expired.

At step 224, responsive to identifying that at least one of the one or more refreshed escalation control thresholds has been surpassed, the dispatch management computing device 131 of the dispatch management server 130 may transmit a cancelation notification to one or more of the vehicle control computer 123 and the mobile device 124 of the dispatch vehicle 120. At step 225, the dispatch management computing device 131 may request a new dispatch in the manner described above in regard to step 205.

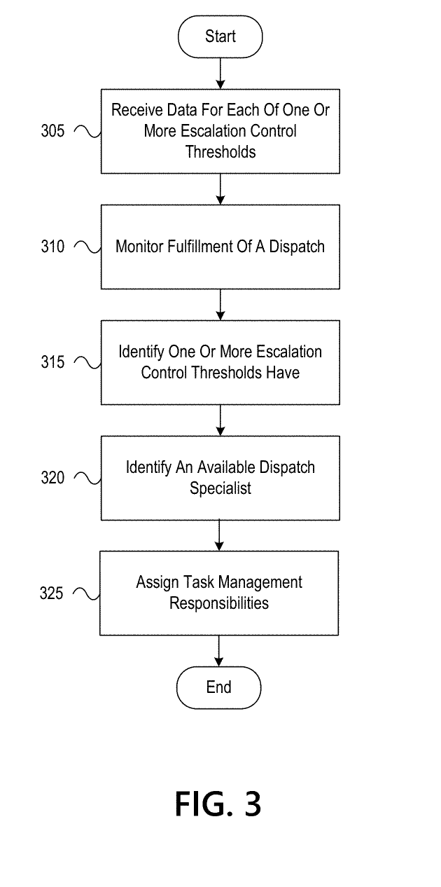

FIG. 3 depicts an illustrative method for using systemic logic to manage fulfillment of a dispatch in accordance with one or more example embodiments. Referring to FIG. 3, at step 305, a dispatch management server having at least one processor, communication interface, and memory, may receive data for each of one or more escalation control thresholds. At step 310, the dispatch management server may monitor fulfillment of a dispatch after an incident based on each of the one or more escalation control thresholds. At step 315, the dispatch management server may identify that at least one of the one or more escalation control thresholds has been surpassed. At step 320, responsive to identifying that at least one of the one or more escalation control thresholds has been surpassed, the dispatch management server may identify an available dispatch specialist out of a plurality of dispatch specialists to receive task management responsibilities. At step 325, responsive to identifying the available dispatch specialist out of the plurality of dispatch specialists to receive the task management responsibilities, the dispatch management server may assign the task management responsibilities to the dispatch specialist.

FIG. 4 illustrates a block diagram of a dispatch control computing device 401 in a system that may be used according to one or more illustrative embodiments of the disclosure. The dispatch control computing device 401 may have a processor 403 for controlling overall operation of the dispatch control computing device 401 and its associated components, including RAM 405, ROM 407, input/output module 409, and memory unit 415. The dispatch control computing device 401, along with one or more additional devices (e.g., terminals 441, 451) may correspond to any of multiple systems or devices, such as dispatch management systems, configured as described herein for performing methods corresponding to the usage of systemic logic to manage fulfillment of a dispatch.

Input/Output (I/O) module 409 may include a microphone, keypad, touch screen, and/or stylus through which a user of the dispatch control computing device 401 may provide input, and may also include one or more of a speaker for providing audio input/output and a video display device for providing textual, audiovisual and/or graphical output. Software may be stored within memory unit 415 and/or other storage to provide instructions to processor 403 for enabling dispatch control computing device 401 to perform various functions. For example, memory unit 415 may store software used by the dispatch control computing device 401, such as an operating system 417, application programs 419, and an associated internal database 421. The memory unit 415 includes one or more of volatile and/or non-volatile computer memory to store computer-executable instructions, data, and/or other information. Processor 403 and its associated components may allow the dispatch control computing device 401 to execute a series of computer-readable instructions to perform the one or more of the processes or functions described herein.

The dispatch control computing device 401 may operate in a networked environment 400 supporting connections to one or more remote computers, such as terminals/devices 441 and 451. Dispatch control computing device 401, and related terminals/devices 441 and 451, may include devices installed in vehicles and/or homes, mobile devices that may travel within vehicles and/or may be situated in homes, or devices outside of vehicles and/or homes that are configured to perform aspects of the processes described herein. Thus, the dispatch control computing device 401 and terminals/devices 441 and 451 may each include personal computers (e.g., laptop, desktop, or tablet computers), servers (e.g., web servers, database servers), vehicle-based devices (e.g., on-board vehicle computers, short-range vehicle communication systems, sensors, and telematics devices), or mobile communication devices (e.g., mobile phones, portable computing devices, and the like), and may include some or all of the elements described above with respect to the dispatch control computing device 401. The network connections depicted in FIG. 4 include a local area network (LAN) 425 and a wide area network (WAN) 429, and a wireless telecommunications network 433, but may also include other networks. When used in a LAN networking environment, the dispatch control computing device 401 may be connected to the LAN 425 through a network interface or adapter 423. When used in a WAN networking environment, the dispatch control computing device 401 may include a modem 427 or other means for establishing communications over the WAN 429, such as network 431 (e.g., the Internet). When used in a wireless telecommunications network 433, the dispatch control computing device 401 may include one or more transceivers, digital signal processors, and additional circuitry and software for communicating with wireless computing devices 441 (e.g., mobile phones, short-range vehicle communication systems, vehicle sensing and telematics devices) via one or more network devices 435 (e.g., base transceiver stations) in the wireless network 433.

It will be appreciated that the network connections shown are illustrative and other means of establishing a communications link between the computers may be used. The existence of any of various network protocols such as TCP/IP, Ethernet, FTP, HTTP and the like, and of various wireless communication technologies such as GSM, CDMA, Wi-Fi, and WiMAX, is presumed, and the various computing devices and components described herein may be configured to communicate using any of these network protocols or technologies.

Additionally, one or more application programs 419 used by the computing device 401 may include computer executable instructions for receiving data and performing other related functions as described herein.

As will be appreciated by one of skill in the art, the various aspects described herein may be embodied as a method, a computer system, or a computer program product. Accordingly, those aspects may take the form of an entirely hardware embodiment, an entirely software embodiment or an embodiment combining software and hardware aspects. Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/we claim:

1. A dispatch management server, comprising:
at least one processor;
a communication interface communicatively coupled to the at least one processor; and
memory storing computer-readable instructions that, when executed by the at least one processor, cause the dispatch management server to:
receive data for each of one or more escalation control thresholds;
monitor fulfillment of a dispatch after an incident based on each of the one or more escalation control thresholds;
identify that at least one of the one or more escalation control thresholds has been surpassed;
responsive to identifying that at least one of the one or more escalation control thresholds has been surpassed, identify an available dispatch specialist out of a plurality of dispatch specialists to receive task management responsibilities; and
responsive to identifying the available dispatch specialist out of the plurality of dispatch specialists to receive the task management responsibilities, assign the task management responsibilities to the available dispatch specialist.

2. The dispatch management server of claim 1, wherein the one or more escalation control thresholds relate to at least one of: estimated time of arrival (ETA) of the dispatch, predictive ETA of the dispatch, ETA extensions taken by the dispatch, and dispatch number associated with the incident.

3. The dispatch management server of claim 1, wherein the predictive ETA is determined by:
access, via the communication interface, a telematics device of a dispatch vehicle associated with the dispatch;
identify, based on the accessed telematics device of the dispatch vehicle associated with the dispatch, a relative location of the dispatch vehicle in relation to a dispatch requester computing device related to the dispatch; and
calculate the predictive ETA based on the relative location.

4. The dispatch management server of claim 1, wherein identifying the available dispatch specialist out of the plurality of dispatch specialists to receive the task management responsibilities includes:
access a database comprising information corresponding to each of the plurality of dispatch specialists;
from the database, produce a list of available dispatch specialists out of the plurality of dispatch specialists by excluding dispatch specialists that are unavailable, work in a group not associated with the dispatch, or have a time conflict;
sort the list of available dispatch specialists based on predetermined criteria; and
identify, from the sorted list of available dispatch specialists, the available dispatch specialist occupying a top most entry of the sorted list to receive the task management responsibilities.

5. The dispatch management server of claim 1, wherein the memory stores further computer-readable instructions that, when executed by the at least one processor, cause the dispatch management server to:
receive, from a computing device associated with the dispatch specialist assigned the task management responsibilities, an update regarding the fulfillment of the dispatch; and
transmit, by the communication interface, the update to a dispatch requester computing device related to the dispatch;
refresh, based on the update regarding the fulfillment of the dispatch, one or more of the escalation control thresholds;
monitor fulfillment of the dispatch based on the one or more refreshed escalation control thresholds;
identify that at least one of the one or more refreshed escalation control thresholds has been surpassed;
responsive to identifying that at least one of the one or more refreshed escalation control thresholds has been surpassed, transmit a cancelation notification to a computing device associated with a dispatch vehicle associated with the dispatch; and
request a new dispatch vehicle.

6. The dispatch management server of claim 1, wherein monitoring fulfillment of the dispatch after the incident based on each of the one or more escalation control thresholds includes:
transmit, to a dispatch requester computing device and a computing device of a dispatch vehicle associated with the dispatch, via the communication interface, a dispatch confirmation;
responsive to transmitting the dispatch confirmation, activate a dispatch timer associated with the dispatch, wherein the dispatch timer is configured to expire upon receipt of a dispatch arrival confirmation; and
based on the dispatch timer, determine whether any of the one or more escalation control thresholds have been surpassed.

7. A method, comprising:
receiving data for each of one or more escalation control thresholds;
monitoring fulfillment of a dispatch after an incident based on each of the one or more escalation control thresholds;
identifying that at least one of the one or more escalation control thresholds has been surpassed;
responsive to identifying that at least one of the one or more escalation control thresholds has been surpassed, identifying an available dispatch specialist out of a plurality of dispatch specialists to receive task management responsibilities; and
responsive to identifying the available dispatch specialist out of the plurality of dispatch specialists to receive the task management responsibilities, assigning the task management responsibilities to the available dispatch specialist.

8. The method of claim 7, wherein the one or more escalation control thresholds relate to at least one of: estimated time of arrival (ETA) of the dispatch, predictive ETA of the dispatch, ETA extensions taken by the dispatch, and dispatch number associated with the incident.

9. The method of claim 7, wherein the predictive ETA is determined by:
accessing a telematics device of a dispatch vehicle associated with the dispatch;
identifying, based on the accessed telematics device of the dispatch vehicle associated with the dispatch, a relative location of the dispatch vehicle in relation to a dispatch requester computing device related to the dispatch; and
calculating the predictive ETA based on the relative location.

10. The method of claim 7, wherein identifying the available dispatch specialist out of the plurality of dispatch specialists to receive the task management responsibilities includes:
accessing a database comprising information corresponding to each of the plurality of dispatch specialists;
from the database, producing a list of available dispatch specialists out of the plurality of dispatch specialists by excluding dispatch specialists that are unavailable, work in a group not associated with the dispatch, or have a time conflict;
sorting the list of available dispatch specialists based on predetermined criteria; and
identifying, from the sorted list of available dispatch specialists, the available dispatch specialist occupying a top most entry of the sorted list to receive the task management responsibilities.

11. The method of claim 7, further comprising:
receiving, from the computing device associated with the dispatch specialist assigned the task management responsibilities, an update regarding the fulfillment of the dispatch;
transmitting the update to a dispatch requester computing device related to the dispatch
refreshing, based on the update regarding the fulfillment of the dispatch, one or more of the escalation control thresholds;
monitoring fulfillment of the dispatch based the one or more refreshed escalation control thresholds; and
identifying that at least one of the one or more refreshed escalation control thresholds has been surpassed.

12. The method of claim 11, further comprising:
responsive to identifying that at least one of the one or more refreshed escalation control thresholds has been surpassed, transmitting a cancelation notification to a computing device associated with a dispatch vehicle associated with the dispatch; and
requesting a new dispatch vehicle.

13. The method of claim 7, further comprising:
transmitting, to a dispatch requester computing device and a computing device of a dispatch vehicle associated with the dispatch, a dispatch confirmation;
responsive to transmitting the dispatch confirmation, activating a dispatch timer associated with the dispatch, wherein the dispatch timer is configured to expire upon receipt of a dispatch arrival confirmation; and
based on the dispatch timer, determining whether any of the one or more escalation control thresholds have been surpassed.

14. One or more non-transitory computer-readable media storing instructions that, when executed by a computing device comprising at least one processor, memory, and a communication interface, cause the computing device to:
receive data for each of one or more escalation control thresholds;
monitor fulfillment of a dispatch after an incident based on each of the one or more escalation control thresholds;
identify that at least one of the one or more escalation control thresholds has been surpassed;
responsive to identifying that at least one of the one or more escalation control thresholds has been surpassed, identify an available dispatch specialist out of a plurality of dispatch specialists to receive task management responsibilities; and
responsive to identifying the available dispatch specialist out of the plurality of dispatch specialists to receive the task management responsibilities, assign the task management responsibilities to the available dispatch specialist.

15. The one or more non-transitory computer-readable media of claim 14, wherein the one or more escalation control thresholds relate to at least one of: estimated time of arrival (ETA) of the dispatch, predictive ETA of the dispatch, ETA extensions taken by the dispatch, and dispatch number associated with the incident.

16. The one or more non-transitory computer-readable media of claim 14, wherein the one or more non-transitory computer-readable media store further instructions that, when executed by the computing device comprising the at least one processor, memory, and the communication interface, cause the computing device to:
access, via the communication interface, a telematics device of a dispatch vehicle associated with the dispatch;
identify, based on the accessed telematics device of a dispatch vehicle associated with the dispatch, a relative location of the dispatch vehicle in relation to a dispatch requester computing device related to the dispatch; and
calculate the predictive ETA based on the relative location.

17. The one or more non-transitory computer-readable media of claim 14, storing further instructions that, when executed by the computing device comprising the at least one processor, memory, and the communication interface, cause the computing device to:
access a database comprising information corresponding to each of the plurality of dispatch specialists;
from the database, produce a list of available dispatch specialists out of the plurality of dispatch specialists by excluding dispatch specialists that are unavailable, work in a group not associated with the dispatch, or have a time conflict;
sort the list of available dispatch specialists based on predetermined criteria; and
identify, from the sorted list of available dispatch specialists, the available dispatch specialist occupying a top most entry of the sorted list to receive the task management responsibilities.

18. The one or more non-transitory computer-readable media of claim 14, storing further instructions that, when executed by the computing device comprising the at least one processor, memory, and the communication interface, cause the computing device to:
receive, from the computing device associated with dispatch specialist assigned the task management responsibilities, an update regarding the fulfillment of the dispatch;
transmit, by the communication interface, the update to a dispatch requester computing device related to the dispatch. refresh, based on the update regarding the fulfillment of the dispatch, one or more of the escalation control thresholds;
monitor fulfillment of the dispatch based the one or more refreshed escalation control thresholds; and
identify that at least one of the one or more refreshed escalation control thresholds has been surpassed.

19. The one or more non-transitory computer-readable media of claim 18, storing further instructions that, when executed by the computing device comprising the at least one processor, memory, and the communication interface, cause the computing device to:
responsive to identifying that at least one of the one or more refreshed escalation control thresholds has been surpassed, transmit a cancelation notification to a computing device associated with a dispatch vehicle associated with the dispatch; and
request a new dispatch vehicle.

20. The one or more non-transitory computer-readable media of claim 19, storing further instructions that, when executed by the computing platform device the at least one processor, memory, and the communication interface, cause the computing device to:
transmit, to a dispatch requester computing device and a computing device of a dispatch vehicle associated with the dispatch, via the communication interface, a dispatch confirmation;
responsive to transmitting the dispatch confirmation, activate a dispatch timer associated with the dispatch, wherein the dispatch timer is configured to expire upon receipt of a dispatch arrival confirmation; and
based on the dispatch timer, determine whether any of the one or more escalation control thresholds have been surpassed.
